(19) United States
(12) Patent Application Publication
(10) Pub. No.: US 2012/0275012 A1
(43) Pub. Date: Nov. 1, 2012

(54) NITROGEN-LINKED SURFACE FUNCTIONALIZED PIGMENTS FOR INKS

(76) Inventors: Zhang-Lin Zhou, Palo Alto, CA (US); Qin Liu, Corvallis, OR (US)

(21) Appl. No.: 13/098,205

(22) Filed: Apr. 29, 2011

(51) Int. Cl. G02F 1/167; C09D 11/00; B82Y 30/00

(52) U.S. Cl. 359/296; 106/31.75; 524/612; 106/31.77; 106/31.78; 977/773

(57) ABSTRACT

A pigment-based ink is disclosed. The ink includes a non-polar carrier fluid and a nitrogen-linked surface functionalized pigment particle, wherein the nitrogen-linked surface functionalized pigment particle is suspended in the non-polar carrier fluid and includes an azide moiety linked to the surface of a pigment particle. The azide moiety further includes an acidic or a basic functional group bonded to it. An electronic display utilizing the pigment-based ink and a method of formulating the pigment-based ink are also disclosed.

### BACKGROUND

Ultrathin, flexible electronic displays that look like print on paper have many potential applications including wearable computer screens, electronic paper, smart identity cards, store shelf labels, and signage applications. Electrophoretic or electrokinetic displays are an important approach to this type of medium. Electrophoretic actuation relies on particles moving under the influence of an electric field. Accordingly, the desired particles must exhibit good dispersibility and charge properties in non-polar dispersing media. Non-polar dispersing media are desirable because they help minimize the leakage currents in electrophoretic or kinetic devices.

Current commercial products based on electrophoretic display technology are only able to provide color and white states or black and white states. They cannot provide a clear or transparent state, which prevents use of a stacked architecture design. A stacked architecture of layered colorants would allow the use of transparent to colored state transitions in each layer of primary subtractive color resulting in print-like color in one display.

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 depicts a cross-sectional view of one example of a stacked electro-optical display.

FIG. 2A is a schematic diagram of an example first reaction scheme for how a functional group may be connected to an azide.

FIG. 2B is a schematic diagram of an example second reaction scheme for surface modification of a pigment particle to include a functional group.

FIG. 3A is a schematic diagram of an example third reaction scheme for how a functional group may be connected to an azide.

FIG. 3B is a schematic diagram of an example fourth reaction scheme for how a functional group may be connected to an azide.

FIGS. 4A and 4B each depict an example of a reaction based on the second reaction scheme.

FIG. 5A is a schematic diagram of an example fifth reaction scheme for how a functional group may be connected to an azide.

FIGS. 5B and 5C together depict a schematic diagram of an example sixth reaction scheme for how a functional group may be connected to an azide.

FIGS. 6A and 6B each depict an example of a reaction based on the second reaction scheme.

FIG. 7 illustrates a cross-sectional view of one example of a lateral electro optical display.

### DESCRIPTION

Aspects of the present invention were developed in relation to electronic inks, but the specification and claims are not so limited.

In the following detailed description, reference is made to the accompanying drawings which form a part hereof, and in which is shown by way of illustration specific examples in which the disclosure may be practiced. In this regard, directional terminology, such as “top,” “bottom,” “front,” “back,” “leading,” “trailing,” etc., is used with reference to the orientation of the Figure(s) being described. Because components of examples can be positioned in a number of different orientations, the directional terminology is used for purposes of illustration and is in no way limiting. It is to be understood that other examples may be utilized and structural or logical changes may be made without departing from the scope of the present disclosure. The following detailed description, therefore, is not to be taken in a limiting sense, and the scope of the present disclosure is defined by the appended claims.

As used herein, the term “grayscale” applies to both black and white images and monochromatic color images. Grayscale refers to an image including different shades of a single color produced by controlling the density of the single color within a given area of a display.

As used herein, the term “over” is not limited to any particular orientation and can include above, below, next to, adjacent to, and/or on. In addition, the term “over” can encompass intervening components between a first component and a second component where the first component is “over” the second component.

As used herein, the term “adjacent” is not limited to any particular orientation and can include above, below, next to, and/or on. In addition, the term “adjacent” can encompass intervening components between a first component and a second component where the first component is “adjacent” to the second component.

As used herein, the term “electronic ink display” is a display that forms visible images using one or more of electrophoresis, electro-convection, electro-osmosis, electrochemical interactions, and/or other electrokinetic phenomena.

As used herein, “about” means a ±10% variance caused by, for example, variations in manufacturing processes.

The article ‘a’ and ‘an’ as used in the claims herein means one or more.

A new versatile class of nitrogen-linked surface functionalized pigments for inks is disclosed. These nitrogen-linked surface functionalized pigments may be functionalized via azide chemistry to include a broad range of acidic and basic functional groups. Additionally, they are easier to manufacture because the pigment particles do not have to be coated with a metal oxide, such as silicon dioxide, before being functionalized, as was required in the past. Finally, these nitrogen-linked surface functionalized pigments exhibit better switching behaviors and longer lifetimes due to the presence of covalent bonding between the functional group and the pigment particle.

Bi-state and/or tri-state electrophoretic or electrokinetic display cells (or elements) having a three-dimensional architecture for compacting charged colorant particles within the display cells are described in US Patent Publication 2010/0245981, published Sep. 30, 2010. A bi-state display cell having a dark state and a clear state is provided by an electronic ink with charged colorant particles in an optically transparent fluid. A clear state is achieved when the colorant particles are compacted, and a colored state is achieved when the colorant particles are spread. An electronic ink with charged white particles in a colored fluid enables white and spot-color states, with the color of the colored state depending on the color of the fluid. The ink fluid is colored by a dye, nanoparticle colorants, pigments or other suitable colorants. A white state is achieved when the white particles are spread, and a colored state is achieved when the white particles are compacted. By combining the white particles in the colored fluid with a colored resin on the back of the display cell, a tri-state display cell is provided.

An electrophoretic display cell may include a three-dimensional architecture to provide a clear optical state. In this architecture, the geometrical shape of the display cell has narrowing portions in which electrophoretically/electrokinetically translated colorant particles compact in response to appropriate bias conditions applied to driving electrodes on opposite sides of the display cell. The three-dimensional structure of the display cell introduces additional control of electrophoretically/electrokinetically moving colorant particles. As a result, desired functionalities can be achieved with a relatively well developed and more stable electrophoretic/kinetic ink. The driving electrodes are passivated with a dielectric layer, thus eliminating the possibility of electrochemical interactions through the driving electrodes from direct contact with the electrophoretic in other examples, the driving electrodes are not passivated, thus allowing electrochemical interactions with the electrophoretic/kinetic ink.

Developing electronic inks that work in an architecture that enables both clear and colored states has been very challenging. As discussed previously, because the materials used in presently-available commercial products do not provide clear states, they do not work in this architecture. While significant progress toward developing working electronic inks for this architecture has been made in the last few years, researchers continue to seek ways for improving the quality and versatility of these inks. See, e.g., PCT/US2009/060971 (“Electronic Inks”); PCT/US2009/060989 (“Dual Color Electronically Addressable Ink”) and PCT/US2009/060975 (“Electronic Inks”), all filed Oct. 16, 2009.

In the production of dual-colorant electronic inks, the polarity of the pigment particles must be controlled, which requires introducing acidic or basic functional groups onto the surfaces of the pigment particles. There is no straightforward reaction to accomplish this type of surface modification, particularly when organic pigments are to be functionalized and dispersed in non-polar media. For example, the most common approach taken by the research community is to mix pigment particles with desired polymers in the presence of other surfactant polymers in order to induce adsorption of the desired polymers onto the pigment particle surface, wherein the surfactant polymers are used to charge and stabilize the pigment dispersions. However, in these functionalized pigments, both the charge and stabilization agents or compounds are not covalently bonded to the pigment surface. As a result, the physically adsorbed polymers easily detach from the pigment particle surface with time and with repeated switching, resulting in the pigment particles losing their charge or suspension.

More recently, the use of functionalized pigments extracted from commercial aqueous dispersions has been studied. However, these dispersions are designed for aqueous inks and are not optimized for non-polar electronic inks.

Improving the switching behavior and the lifetime of electronic inks is one route to commercializing color electrokinetic reflective display (EKD) and electronic skin (eSkin) technologies. The nitrogen-linked surface functionalized pigments disclosed herein are formulated using a novel surface treatment technology that functionalizes pigments via azide chemistry. These nitrogen-linked surface functionalized pigments are created using a novel surface treatment that involves introducing the desired functional groups onto an azide and then, reacting the azide with pigment particles via azide chemistry in order to form covalently bonded, surface functionalized pigments.

These nitrogen-linked surface functionalized pigments have a number of advantages. First, in the past, the non-reactive pigment particle needed to be coated with a metal oxide coating, such as a silica coating, before it could be linked to desired functional groups. However, when azide chemistry is used, the non-specific nature of the reactions allows this requirement to be removed. For example, the reacting nitrogene species may react with various bonds such as C—H, O—H, N—H, S—H or carbon-carbon double bonds or triple bonds in both organic and inorganic compounds to form nitrogen-carbon, nitrogen-nitrogen, nitrogen-oxygen or nitrogen-sulfur bonds. Second, since azide chemistry is versatile and involves non-specific reactions, a wide range of organic and inorganic pigments can be functionalized. Third, because the functional groups are linked to the pigment particles via covalent bonds as opposed to simple adsorption as they were in the past, the functional groups are much less likely to detach from the pigment particles and may be formulated into electronic inks with better switching behaviors and longer lifetimes, as compared to those inks including pigments with surfaces functionalized through physio-sorption.

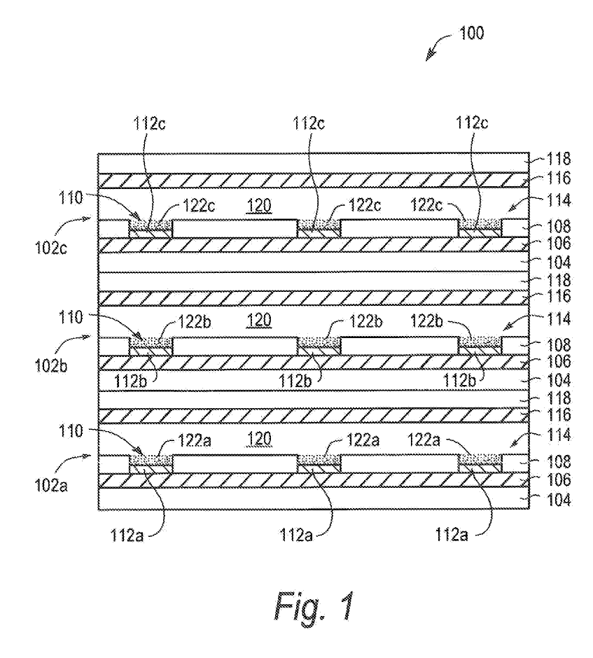

FIG. 1 illustrates a cross-sectional view of one example of a stacked electro-optical display 100. The electro-optical display 100 includes a first display element 102a, a second display element 102b, and a third display element 102c. The third display element 102c is stacked on the second display element 102b, and the second display element 102b is stacked on the first display element 102a.

Each display unit includes a first substrate 104, a first electrode 106, a dielectric layer 108 including reservoir or recess regions 110, thin layers 112, a display cell 114, a second electrode 116, and a second substrate 118. The display cell 114 is filled with a carrier fluid 120 including colorant particles 122. In some examples, the thin layers 112 may be opaque. In other examples, the thin layers 112 may be transparent.

The first display element 102a includes thin layers 112a self-aligned within the recess regions 110. The first display element 102a also includes colorant particles 122a having a first color (e.g., cyan) for a full color electro-optical display. The second display element 102b includes thin layers 112b self-aligned within the recess regions 110. The second display element 102b also includes colorant particles 122b having a second color (e.g., magenta) for a full color electro-optical display. The third display element 102c includes thin layers 112c self-aligned within the recess regions 110. The third display element 102c also includes colorant particles 122c having a third color (e.g., yellow) for a full color electro-optical display. In other examples, colorant particles 122a, 122b, and 122c may include other suitable colors for providing an additive or subtractive full color electro-optical display.

In the example illustrated in FIG. 1, in the electro-optical display 100, the first display element 102a, the second display element 102b, and the third display element 102c are aligned with each other. As such, the thin layers 112a, 112b, and 112c are also aligned with each other. In this example, since the recess regions 110 and the self-aligned thin layers 112a, 112b, and 112c of each display element 102a, 102b, and 102c, respectively, are aligned, the clear aperture for the stacked electro-optical display 100 is improved as compared to a stacked electro-optical display without such alignment.

In an alternate example (not shown), the first display element 102a, the second display element 102b, and the third display element 102c may be offset from each other. As such, the thin layers 112a, 112b, and 112c are also offset from each other. In this example, since the recess regions 110 and the self-aligned thin layers 112a, 112b, and 112c are just a fraction of the total area of each display element 102a, 102b, and 102c, respectively, the clear aperture for the stacked electro-optical display 100 remains high regardless of the alignment between the display elements 102a, 102b, and 102c. As such, the process for fabricating the stacked electro-optical display 100 is simplified. The self-aligned thin layers 112a, 112b, and 112c prevent tinting of each display element due to the colorant particles 122a, 122b, and 122c, respectively, in the clear optical state. Therefore, a stacked full color electro-optical display having a bright, neutral white state and precise color control is provided.

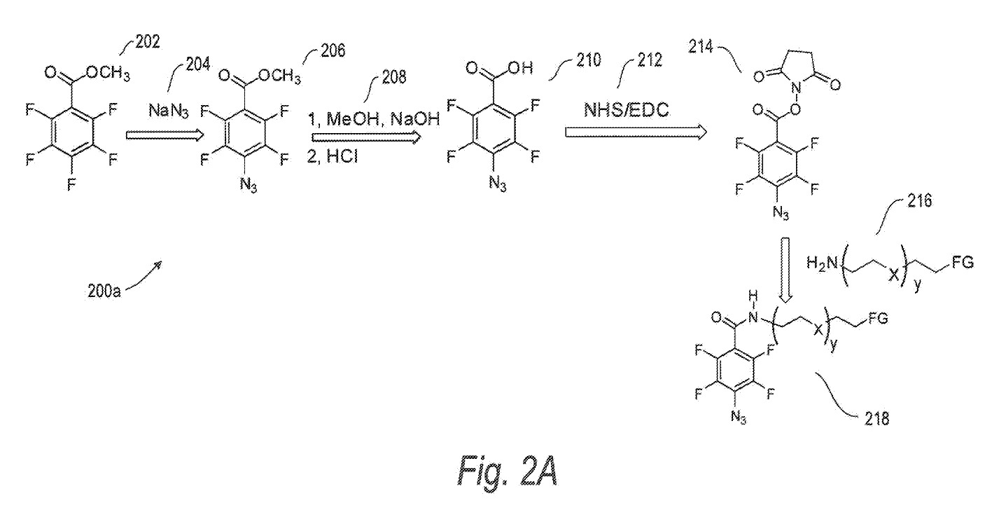

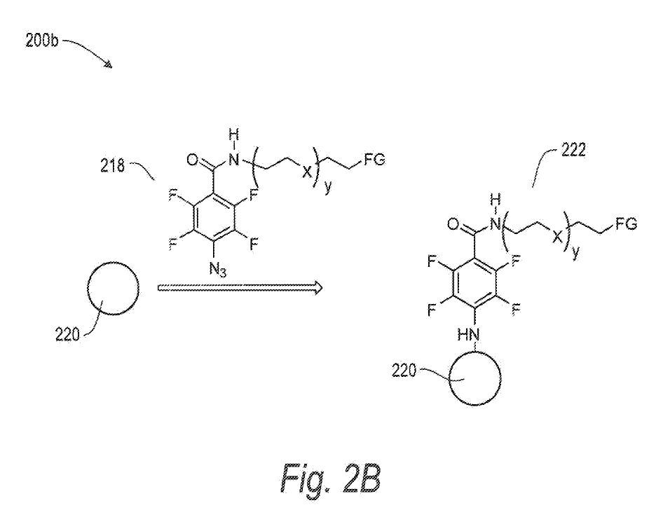

FIG. 2A is a schematic diagram of an example reaction scheme depicting how a functional group may be connected to an azide. In one example and as depicted in the example reaction scheme 200a, tetrafluorophenyl azide may be functionalized to include a desired functional group. In other examples, any azide may be functionalized to include a desired functional group.

It should be noted that this discussion is presented largely in terms of tetrafluorophenyl azide for the sake of convenience and because tetrafluorophenyl azide is a highly efficient reagent. However, it is noted that other azides may also be functionalized in accordance with the reaction schemes described herein to include a desired functional group.

Tetrafluorophenyl azide is commonly used in azide reactions because it reacts highly efficiently in comparison to other aromatics and non-aromatics. The high efficiency of tetrafluorophenyl azide in reactions is due to the presence of fluorine groups, which serve as powerful electron withdrawing groups that can activate the benzene ring. In other examples, the starting reagent in azide reactions may be methyl benzoate substituted with other halogens, such as chlorine or bromine groups. However, these other halogens are less electronegative and are not as powerful an electron withdrawing group. Accordingly, methyl benzoate substituted with chlorine or bromine groups may not react as efficiently as methyl benzoate substituted with fluorine groups. Additionally, although other aromatics may be substituted with fluorine groups as well, these fluoro-substituted aromatics are often more expensive to formulate and accordingly, may be less economical than fluoro-substituted benzenes. Finally, although non-aromatics may be used in place of aromatics, reactions with non-aromatics are harder to control. For example, a non-aromatic nitrene is very reactive and may polymerize.

In the first step of the example reaction scheme 200a, a halogen on a substituted ester 202 is a replaced with an azide group (N₃) 204 via nucleophilic substitution. In the second step, the newly azide substituted ester 206 may undergo hydrolysis 208 to yield an acid 210. Third, the acid 210 may undergo a condensation reaction 212 to form a reactive ester 214. Finally, the reactive ester 214 may be exposed to a functional group (FG) 216 to yield a FG modified azide 218.

In one example, in the first step, commercially available methyl pentafluorobenzoate 202 may be reacted with sodium azide 204 via nucleophilic substitution to yield an azide substituted ester 206. In other examples, any other alkyl pentafluorobenzoate or other per-fluorosubstituted aromatic esters may be used in place of methyl pentafluorobenzoate and any azide salt, such as potassium azide, may be used in place of sodium azide. However, as previously noted, these other starting reagents create azide compounds that may be less efficient in azide chemistry reactions.

In the second step, in one example wherein methyl pentafluorobenzoate 202 is used, the azide substituted ester 206 may undergo hydrolysis 208 to yield a tetrafluorophenyl acid 210. In some examples, hydrolysis 208 may be accomplished by reacting the compound including a carboxylic acid ester group, tetrafluorophenyl acid ester 208 in this case, with an alcohol in the presence of a base reagent. In one example, the alcohol used may be methanol. In some examples, other alcohols, such as ethanol or propanol, may be used. In other examples, the alcohol may be combined with one or more other bases such as sodium hydroxide, potassium hydroxide, ammonium hydroxide, lithium hydroxide, cesium hydroxide or calcium hydroxide. In other examples, a base such as the ones listed above may be used in place of an alcohol. Following hydrolysis, the reaction mixture may be acidified using an acid catalyst. In one example, tetrafluorophenyl acid ester 206 may be acidified to form tetrafluorophenyl acid 210. In one example, the acid catalyst used may be hydrochloric acid. In other examples, sulfuric acid, tosylic acid or any Lewis acid may be used.

Third, also in the example wherein methyl pentafluorobenzoate 202 is used, the tetrafluorophenyl acid 210 may then undergo a condensation reaction 212 to yield an activated ester 214. In some examples, condensation 212 is accomplished by exposing the tetrafluorophenyl acid to N-hydroxysuccinimide (NHS) in the presence of 1-ethyl-3-(3-dimethylaminopropyl)carbodiimide hydrochloric acid (EDC). In other examples, N-hydroxyphthalimide, pentafluorophenol, ethyl dimethylaminopropylcarbodiimide (EDAC) or dicyclohexylcarbodiimide (DCC) may be used.

Finally, in the example wherein methyl pentafluorobenzoate 202 is used, after the activated ester 214 has been formed, it may then be reacted with an amine compound including a desired FG 216 to yield a FG modified azide FG 218. In other examples, any azide may be functionalized to include a FG. The mechanism for achieving such functionalization is substantially the same as described above.

In some examples, the amine compound including the desired FG may have the structure of the amine compound 216, wherein “y” may have an integer value between 1 and 10, inclusive, and accordingly, may indicate an amine compound 216 with 1 to 10 repeating middle units. In some examples, “X” may refer to heteroatoms, such as oxygen, sulfur or nitrogen. In other examples, the heteroatoms may be any atom that is not hydrogen. In yet other examples, the amine compound 216 may include branched alkyl groups. However, amine compounds including branched alkyl groups may be harder to make and may be less reactive, as they tend to be sterically hindered.

The FG in the amine compound 216 may be either an acidic functional group or a basic functional group. In some examples, the FG in the amine compound 216 may be an acidic functional group, such as —OH, —SH, —COOH, —CSSH, —COSH, —SO₃H, —PO₃H, —OSO₃H or —OPO₃H. In other examples, the FG in the amine compound 216 may be a basic functional group, such as trialkyamine, R₁R₂N—, pyridines, pyridines substituted with alkyl or branched alkyl groups, imidazoles or imidazoles substituted with alkyl or branched alkyl groups. In some examples wherein the FG in the amine compound 216 is R₁R₂N—, R₁ and R₂ may be, independently, hydrogen or any alkyl or branched alkyl groups, such as methyl, ethyl, propyl, isopropyl, butyl, iso-butyl, n-octyl, n-decyl, n-dodecyl or n-tetradecyl.

FIG. 2B is a schematic diagram of an example reaction scheme for surface modification of a pigment particle to include a FG. In the example reaction scheme 200b depicted in FIG. 2B, the surface of a pigment particle 220 may react with a FG functionalized azide 218 to yield a nitrogen-linked surface functionalized pigment 222.

In some examples, this surface modification may be achieved under UV irradiation. In other examples, this surface modification may be achieved using heat. When UV irradiation is used, the FG functionalized azide 218 and pigment particle 220 are exposed to UV light at a wavelength between 280 to 400 nm. In some examples, the FG functionalized azide 218 and the pigment particle 220 are exposed to UV light in a solvent. In these examples, the solvent used may be acetonitrile, chloroform, acetone, dimethylformamide, anisole or N-methylpyrrolidone. In UV irradiation, when the FG functionalized azide 218 is exposed to UV light, it may lose a nitrogen gas (N₂) molecule, forming a reactive nitrene intermediate that can react with the pigment particle 220 in an insertion reaction between the nitrene and a C—H, O—H, N—H or carbon-carbon double or triple bond on the surface of the pigment particle 220. Afterwards, the newly FG functionalized pigment particle 222 may be washed in solvent for purification purposes. In some examples, solvents such as hexanes, ethyl acetate, acetone, methanol, ethanol or chloroform may be used. When functionalization is achieved through heat, a mixture of the pigment particle 220 and the FG functionalized azide 218 in a solvent may be heated to a temperature between 25 and 200° C. and for a period of time between 0.1 and 24 hours. In some examples, the solvent used may be chosen from the same list of solvents used in functionalization of the pigment particle by UV irradiation. Afterwards, the newly FG functionalized pigment particle 222 may be purified in the same manner as it is when UV irradiation is used.

The pigment particle 220 may be a colored pigment or colored polymeric particle in any possible color, such as RGB or CYMK, with a size ranging from 50 nm to 1 μm. In some examples, smaller particles, with a particle size of a few nanometers, such as quantum dots, may be employed. In other examples, the particle size may range to a few micrometers. Additionally, as described above, because of the non-specific nature of azide chemical reactions, organic or inorganic pigments may be used.

In general, the organic or inorganic pigment particles may have an average particle size ranging from about 1 nm to about 10 μm. In some examples, the average particle size may range from about 10 nm to about 1 μm. In other examples, the average particle size may range from about 30 to 500 nm. Such organic or inorganic pigment particles may be selected from black pigment particles, yellow pigment particles, magenta pigment particles, red pigment particles, violet pigment particles, cyan pigment particles, blue pigment particles, green pigment particles, orange pigment particles, brown pigment particles or white pigment particles. In some instances, the organic or inorganic pigment particles may include spot-color pigment particles, which are formed from a combination of a predefined ratio of two or more primary color pigment particles. To the extent that the generic pigments on the foregoing list can be functionalized as taught herein, such pigments may be used in the practice of the teachings herein. Likewise, to the extent that the following examples of specific pigments can be functionalized as taught herein, such pigments may be used in the practice of the teachings herein.

A non-limiting example of a suitable inorganic black pigment includes carbon black. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100 or No. 2200B) various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255 or RAVEN® 700): various carbon black pigments of the REGAL® series, the MOGUL® series or the MONARCH® series manufactured by Cabot Corporation, Boston, Mass., (such as, e.g., REGAL® 400R, REGAL® 330R, REGAL® 660R, MOGUL® L, MONARCH® 700, MONARCH® 800, MONARCH® 880, MONARCH® 900, MONARCH® 1000, MONARCH® 1100, MONARCH® 1300 or MONARCH® 1400); or various black pigments manufactured by Evonik Degussa Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® U, PRINTEX® V, PRINTEX® 140U, Special Black 5, Special Black 4A or Special Black 4). A non-limiting example of an organic black pigment includes aniline black, such as C.I. Pigment Black 1.

Other examples of inorganic pigments include metal oxides and ceramics, such as the oxides of iron, zinc, cobalt, manganese or nickel. Non-limiting examples of suitable inorganic pigments include those from the Shepherd Color Company (Cincinnati, Ohio) such as Black 10C909A, Black 10P922, Black 1G, Black 20F944, Black 30C933, Black 30C940, Black 30C965, Black 376A, Black 40P925, Black 411A, Black 430, Black 444, Blue 10F545, Blue 10G511, Blue 10G551, Blue 10K525, Blue 10K579, Blue 211, Blue 212, Blue 214, Blue 30C527, Blue 30C588, Blue 30C591, Blue 385, Blue 40P585, Blue 424, Brown 10C873, Brown 10P835, Brown 10P850, Brown 10P857, Brown 157, Brown 20C819, Green 10K637, Green 187 B, Green 223, Green 260, Green 30C612, Green 30C654, Green 30C678, Green 40P601, Green 410, Orange 10P320, StarLight FL 37, StarLight FL105, StarLight FL500, Violet 11, Violet 11C, Violet 92, Yellow 10P112, Yellow 10C242, Yellow 10C272, Yellow 10P110, Yellow 10P225, Yellow 10P270, Yellow 196, Yellow 20P296, Yellow 30C119, Yellow 30C236, Yellow 40P140 or Yellow 40P280.

In addition to the foregoing inorganic pigments that may have their surfaces fluorinated as taught herein, the same teachings may be employed with organic pigments. The following is a list of organic pigments that may be treated accordance with the teachings herein.

Non-limiting examples of suitable yellow pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, Pigment Yellow 155, C.I. Pigment Yellow 167, C.I. Pigment Yellow 172 or C.I. Pigment Yellow 180.

Non-limiting examples of suitable magenta or red or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43 or C.I. Pigment Violet 50.

Non-limiting examples of blue or can organic pigments include C.I. Pigment Blue 1, C.I. Pigment Blue 2, C.I. Pigment Blue 3, C.I. Pigment Blue 15, C.I. Pigment Blue 15:3, C.I. Pigment Blue 15:34, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4 or C.I. Vat Blue 60.

Non-limiting examples of green organic pigments include C.I. Pigment Green 1, C.I. Pigment Green 2, C.I. Pigment Green, 4, C.I. Pigment Green 7, C.I. Pigment Green 8, C.I. Pigment Green 10, C.I. Pigment Green 36 or C.I. Pigment Green 45.

Non-limiting examples of brown organic pigments include C.I. Pigment Brown 1, C.I. Pigment Brown 5, C.I. Pigment Brown 22, C.I. Pigment Brown 23, C.I. Pigment Brown 25, and C.I. Pigment Brown, C.I. Pigment Brown 41 or C.I. Pigment Brown 42.

Non-limiting examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43 or C.I. Pigment Orange 66.

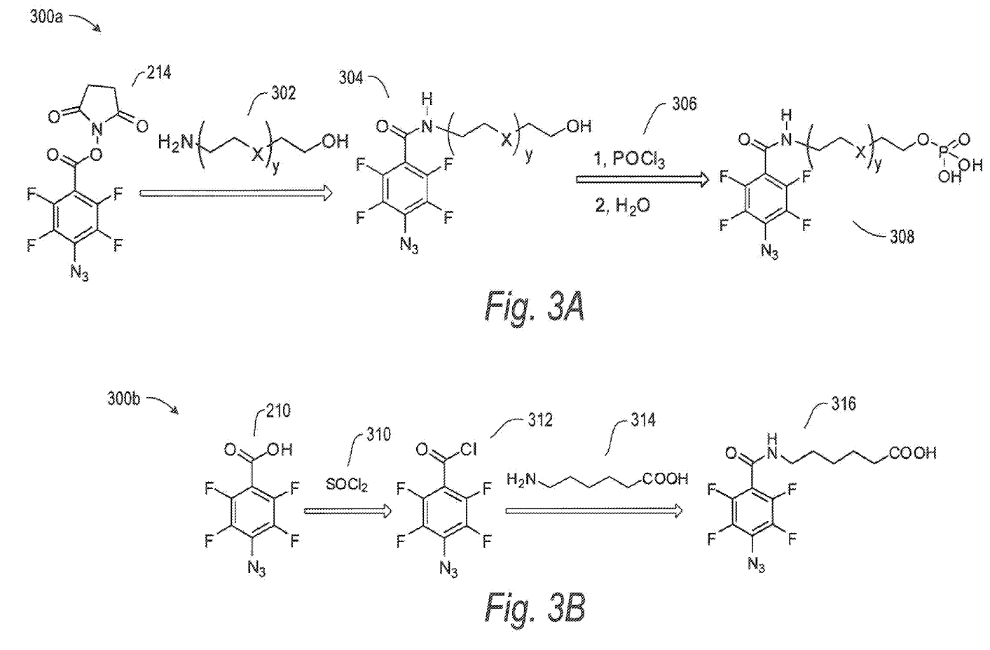

FIGS. 3A and 3B are schematic diagrams of example reaction schemes depicting how a functional group may be connected to an azide. FIG. 3A depicts an example reaction for preparing a hydroxyl phosphate modified azide. First, an activated ester including an azide 214 may be reacted with an amino alcohol 302 to yield an intermediate 304. Then, the intermediate 304 may be reacted with phosphorus oxychloride 306 in the presence of a solvent to yield a hydroxyl phosphate modified azide 308.

In one example, the first step, the activated ester 214 is formed using the reaction scheme discussed in FIG. 2A. In some examples, the amine alcohol 302, an amine compound with a hydroxyl FG similar to the amine compound 216 described previously, may have an integer value between 1 and 10 inclusive for “y” and accordingly, may be an amino alcohol 302 with between 1 and 10 repeating middle units. In some examples, “X” may refer to heteroatoms, such as oxygen, sulfur or nitrogen. In other examples, the heteroatoms may be any atom that is not hydrogen. In yet other examples, the amino alcohol 302 may include branched alkyl groups. However, as explained previously, such amine compounds including branched alkyl groups may be harder to make and may be less reactive, as they tend to be sterically hindered.

Next, in one example, wherein the intermediate is a tetrafluorophenyl azide including a hydroxyl group 304, the intermediate 304 may be reacted with phosphorus oxychloride 306 in the presence of a solvent to yield a hydroxyl phosphate modified tetrafluorophenyl azide 308, similar to the FG modified tetrafluorophenyl azide 218 resulting from the example reaction scheme 200a discussed previously. In some reactions, the solvent used may be dichloromethane, chloroform, dimethylformamide or water.

FIG. 38 depicts an example reaction for preparing a hexanoic acid modified azide. First, an azide substituted acid 210 may be reacted with thionyl chloride 310 to form an azide acid chloride 312. Next, the azide acid chloride 312 may be reacted with an amino acid 314, an amine compound including an acid FG similar to the amine compound 216 described previously, to form an acid modified azide 316. in some examples (not shown), the amino acid 314 may be in the form of amine compound 216, wherein “y” has an integer value between 1 and 10, and “X” may refer to carbon or heteroatoms, such as oxygen, sulfur, nitrogen or any atom that is not hydrogen. Additionally, as discussed previously, the amino acid 314 may include branched alkyl groups, although amine compounds with these branched groups may be harder to make and may be less reactive, as they tend to be sterically hindered.

In one example, the tetrafluorophenyl acid 210 may be reacted with thionyl chloride 310 to yield tetrafluorophenyl azide acid chloride 312. In another example, oxalyl chloride may be used in place of thionyl chloride. Next, the tetrafluorophenyl azide acid chloride 312 may be reacted with an amino acid 314 to yield a carboxylic acid modified tetrafluorophenyl azide 316. In other examples, this mechanism may be used to modify an azide to include other acids, such as —OH, —SH, —COOH, —CSSH, —COSH, —SO₃H, —PO₃H, —OSO₃H or —OPO₃H.

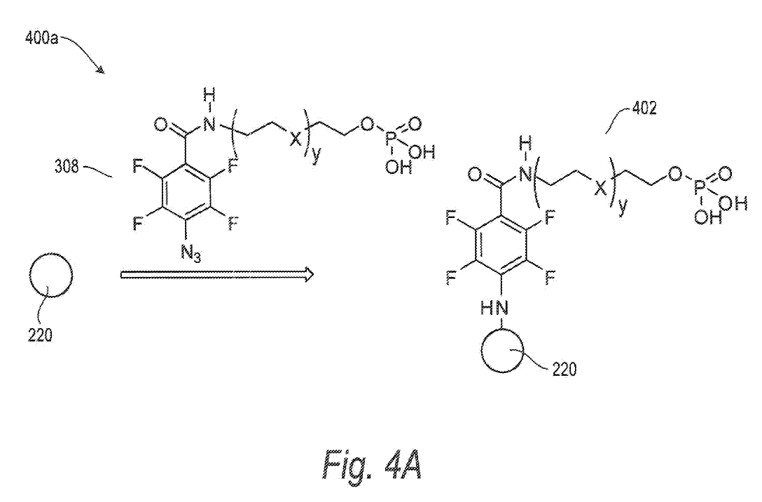

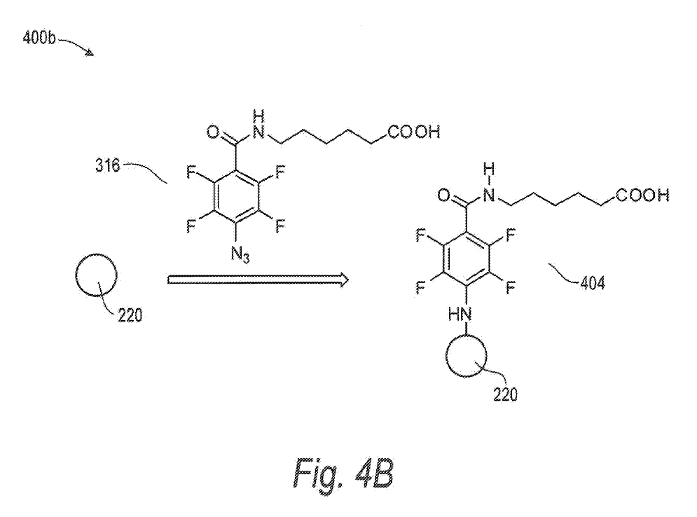

FIGS. 4A and 4B each depict an example of a reaction based on the second reaction scheme. FIG. 4A is an example reaction for the surface modification of a pigment particle using a hydroxyl phosphate modified azide. In one example, a hydroxyl phosphate modified pigment particle 402 can be formed from a hydroxyl phosphate tetrafluorophenyl azide 308 and a pigment particle 220.

In some examples, surface modification of a pigment particle 220 to include a hydroxyl phosphate modified azide 308 may occur upon UV irradiation. In other examples, the surface modification may take place upon exposure to heat. The mechanisms for these surface modification processes are the same as discussed previously in FIG. 2B. In other examples, any hydroxyl phosphate modified azide may be combined with a pigment particle 220.

FIG. 4B is an example reaction for the surface modification of a pigment particle using an acid modified azide. In one example, a carboxylic acid modified pigment particle 404 can be formed from a carboxylic acid tetrafluorophenyl azide 316 and a pigment particle 220. In other examples, any carboxylic acid modified azide may be combined with a pigment particle 220. In yet other examples, this mechanism may also be used with other acid modified azides including —OH, —SH, —CSSH, —COSH, —SO₃H, —PO₃H, —OSO₃H or —OPO₃H.

In some examples, surface modification of a pigment particle to include an acid modified azide may occur upon UV irradiation. In other examples, the surface modification may take place upon exposure to heat. Again, the mechanism for this surface modification process is the same as was discussed previously in FIG. 2B.

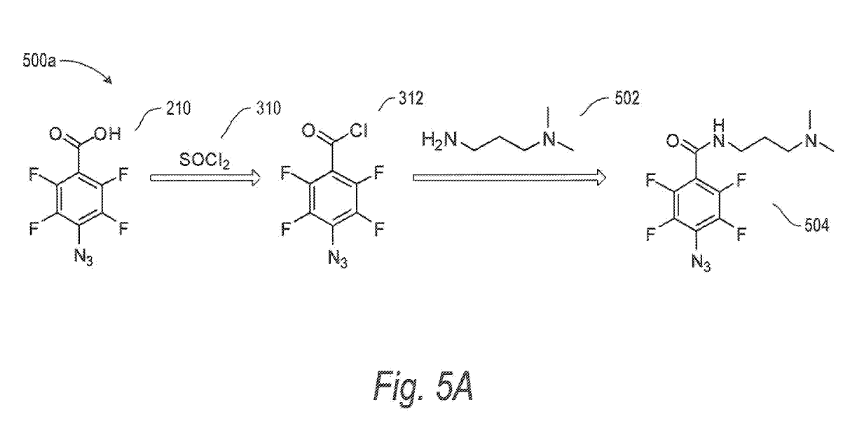

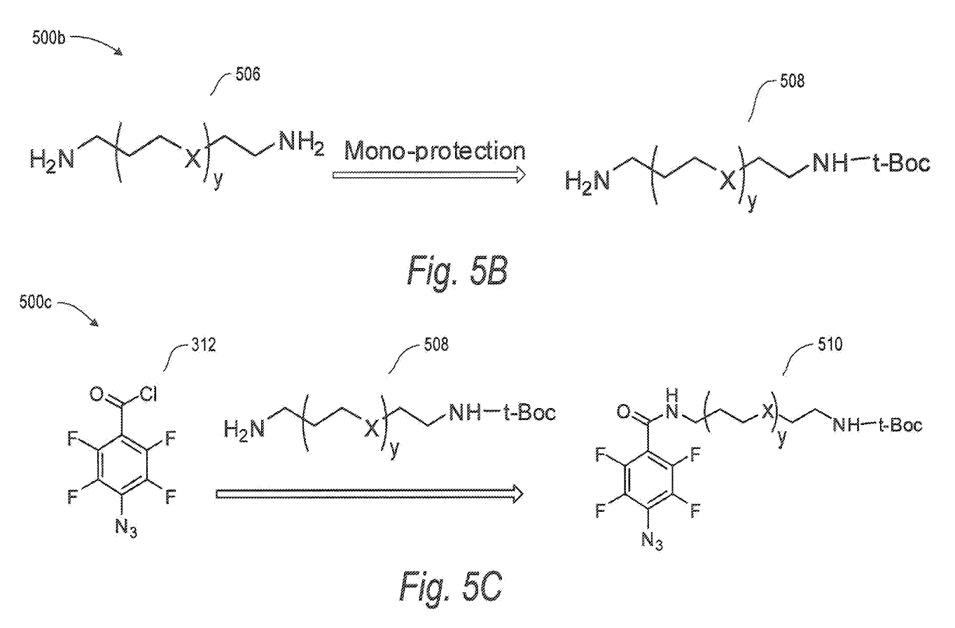

FIG. 5A is a schematic diagram of an example fifth reaction scheme for how a functional group may be connected to an azide. First, an azide acid 210 may be reacted with thionyl chloride 310 to yield an azide acid chloride 312. Next, the azide acid chloride 312 may be exposed to an amine compound 502 to yield an amine modified azide 504.

In one example, dimethylaminopropyl modified tetrafluorophenyl azide 504 may be prepared using this reaction scheme. In the example reaction scheme 500a, tetrafluorophenyl azide acid 210, which may be prepared in a manner described in FIG. 2A, may be reacted with thionyl chloride 310 to yield tetrafluorophenyl azide acid chloride 312. In other examples, oxalyl chloride may be used in place of thionyl chloride 310.

Next, in one example, the tetrafluorophenyl azide acid chloride 312 may be reacted with dimethylaminopropylamine 502, an amine compound including an amine FG similar to the amine compound 216 described previously, to yield dimethylaminopropyl modified tetrafluorophenyl azide 504. In other examples, any amine compound with a tertiary amine functional group may be used in place of dimethylaminopropylamine 502.

FIGS. 5B and 5C together depict a schematic diagram of an example sixth reaction scheme for how a functional group may be connected to an azide. In particular, FIGS. 5B and 5C depict how a primary amine FG may be connected to an azide. As seen in FIG. 5B, the primary amine FG 506 may first be protected 508. Next, it may be reacted with an azide acid chloride 312 to form a protected amine modified azide 510. In other examples, secondary and tertiary amines may be connected to an azide as well. In these examples, the amine groups may be protected in the same manner as described below.

In one example, di-tert-butyl dicarbonate (“tert-Boc” or “t-Boc”) protected aminoethyl modified tetrafluorophenyl azide may be prepared using this reaction scheme. First, in order to ensure that only one amine in a diamino compound 506 will be available to react, the diamino compound 506 may undergo mono-protection with t-Boc in order to yield a t-Boc mono-protected amine 508. In other examples, carbamates such as methyl or ethyl carbamate: 9-fluorenylmethyl carbamate; substituted ethyl carbamates such as 2,2,2-trichloroethyl carbamate, 2-trimethylsilylethyl carbamate, p-methoxybenzyl carbamate, p-nitrobenzyl carbamate, p-chlorobenzyl carbamate or p-bromobenzyl carbamate; amides such as N-chloroacetyl amide, N-picolinoyl amide, N-trifluoroacetyl amide or N-benzoyl amide; or cyclic imidederivatives such as N-phthaloylimide, N-tetrachlorophthaloyl imide or N-4-nitrophthaloyl imide may be used to protect the primary amine 506. The t-Boc mono-protected or otherwise protected amine 508 may then be reacted with tetrafluorophenyl azide acid chloride 312, as described previously, to yield t-Boc protected aminoethyl modified tetrafluorophenyl azide 510.

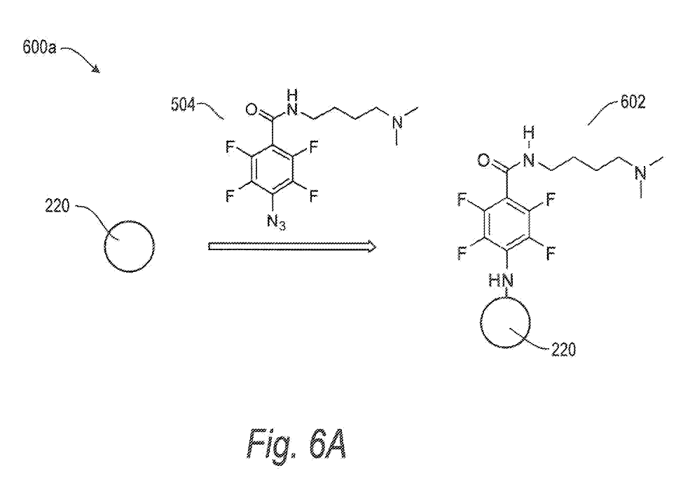

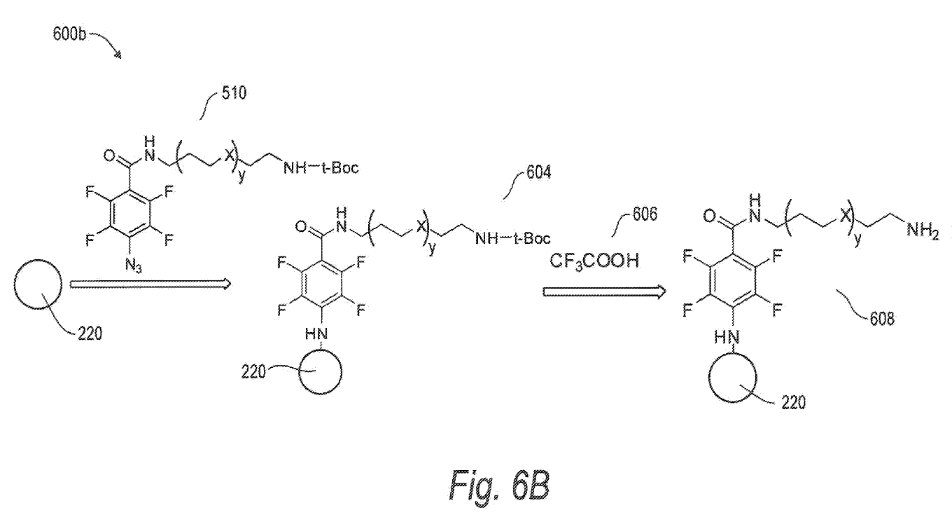

FIGS. 6A and 6B depict two example reactions for surface modification of pigments. FIG. 6A is an example reaction for the surface modification of a pigment particle using a tertiary amine modified azide. In one example, a dimethylaminopropyl modified pigment 802 may be formed. In some examples, surface modification of a pigment particle 220 to include dimethylaminopropyl modified tetrafluorophenyl azide 504 may occur upon UV irradiation. In other examples, the surface modification may take place upon exposure to heat. The mechanisms for these surface modification processes are the same as discussed previously in FIG. 2B.

FIG. 6B is an example reaction for the surface modification of a pigment particle using a protected amine modified azide. In one example, the protected amine modified azide may be t-Boc protected aminoethyl modified tetrafluorophenyl azide 510. In some examples, surface modification of a pigment particle 220 to include t-Boc protected aminoethyl modified tetrafluorophenyl azide 510 may occur upon UV irradiation. In other examples, the surface modification may take place upon exposure to heat. The mechanisms for these surface modification processes are the same as discussed previously in FIG. 2B.

After surface modification, the protected amine may be treated with acid in order to remove the protection. In one example, t-Boc protected aminoethyl modified pigment particle 604 may be treated with trifluoroacetic acid 606 in order to yield an amino functionalized pigment 608. In other examples, alternative suitable acids for removing protection include hydrochloric acid, hydrobromic acid, phosphoric acid, dilute nitric acid or dilute sulfuric acid.

Turning now to electronic inks that employ the nitrogen-linked surface modified pigments, such as the FG modified pigment 222 in FIG. 2B discussed above, examples of such electronic inks generally include a non-polar carrier fluid (i.e., a fluid having a low dielectric constant k such as, e.g., less than about 20 or, in some cases, less than about 2). Such fluids tend to reduce leakages of electric current when driving the display, as well as increase the electric field present in the fluid. As used herein, the “carrier fluid” is a fluid or medium that fills up a viewing area defined in an electronic ink display and is generally configured as a vehicle to carry colorant particles therein. In response to a sufficient electric potential or field applied to the colorant particles while driving electrodes of the display, the colorant particles tend to move and/or rotate to various spots within the viewing area in order to produce a desired visible effect in the display cell to display an image. In some examples, examples of the non-polar carrier fluid may include one or more non-polar carrier fluids selected from hydrocarbons, halogenated or partially halogenated hydrocarbons or siloxanes. Some specific examples of non-polar carrier fluids may include, but are not limited to, perchloroethylene, cyclohexane, dodecane, mineral oil, isoparaffinic fluids, cyclopentasiloxane, cyclohexasiloxane, cyclooctamethylsiloxane or combinations thereof.

In some examples, colorant particles may be dispersed in the carrier fluid. As used herein, the term “colorant particles” refers to particles that produce a color. Some non-limiting examples of suitable colorant particles include the nitrogen-linked surface functionalized pigments described herein. In a non-limiting example, the colorant particles may be selected from pigment particles that are self-dispersible in the non-polar carrier fluid. It is to be understood, however, that non-dispersible pigment particles may otherwise be used so long as the electronic ink includes one or more suitable dispersants. Such dispersants include hyperdispersants such as those of the SOLSPERSE® series manufactured by Lubrizol Corp., Wickliffe, Ohio (e.g., SOLSPERSE® 3000, SOLSPERSE® 8000, SOLSPERSE® 9000, SOLSPERSE® 11200, SOLSPERSE® 13840, SOLSPERSE® 16000, SOLSPERSE® 17000, SOLSPERSE® 18000, SOLSPERSE® 19000, SOLSPERSE® 21000 or SOLSPERSE® 27000); various dispersants manufactured by BYKchemie, Gmbh, Germany, (e.g., DISPERBYK® 110, DISPERBYK® 163, DISPERBYK® 170 or DISPERBYK® 180); various dispersants manufactured by Evonik Goldschmidt GMBH LLC, Germany, (e.g., TEGO® 630, TEGO® 660, TEGO® 651, TEGO® 655, TEGO® 685 or TEGO® 1000); or various dispersants manufactured by Sigma-Aldrich, St, Louis, Mo., (e.g., SPAN® 20, SPAN® 60, SPAN® 80 or SPAN® 85).

In some examples, the concentration of colorant particles in the electronic ink may range from about 0.5 to 20 percent by weight (wt %). In other examples, the concentration of the colorant particles in the electronic ink may range from about 1 to 10 wt %. In some examples, the concentration of dispersant in the electronic ink may range from about 0.5 to 20 percent by weight (wt %). In other examples, the concentration of the dispersant may range from about 1 to 10 wt %. The carrier fluid makes up the balance of the ink.

There is commonly a charge director employed in electronic inks. As used herein, the term “charge director” refers to a material that, when used, facilitates charging of the colorant particles. In one example, the charge director may be basic and may react with the acid-modified colorant particle to negatively charge the particle. In other words, the charging of the particle may be accomplished via an acid-base reaction between the charge director and the acid-modified particle surface. It is to be understood that the charge director may also be used in the electronic ink to prevent undesirable aggregation of the colorant in the carrier fluid. In other cases, the charge director may be acidic and may react with the base-modified colorant particle to positively charge the particle. Again, the charging of the particle may be accomplished via an acid-base reaction between the charge director and the base-modified particle surface.

The charge director may be selected from small molecules or polymers that are capable of forming reverse micelles in the non-polar carrier fluid. Such charge directors are generally colorless and tend to be dispersible or soluble in the carrier fluid.

In a non-limiting example, the charge director may be selected from a neutral and non-dissociable monomer or polymer such as, e.g., a polyisobutylene succinimide amine, which has a molecular structure as follows:

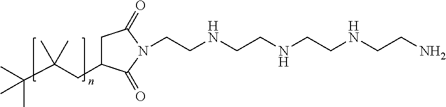

where “n” is selected from a whole number ranging from 15 to 100.

Another example of the charge director includes an ionizable molecule that is capable of disassociating to form charges. Non-limiting examples of such charge directors include sodium di-2-ethylhexylsulfosuccinate or dioctyl sulfosuccinate. The molecular structure of dioctyl sulfosuccinate is as follows:

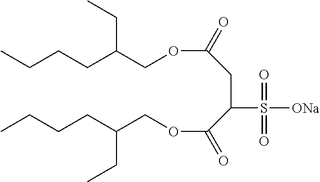

Yet another example of the charge director includes a zwitter on charge director such as, e.g., lecithin. The molecular structure of lecithin is as shown as follows:

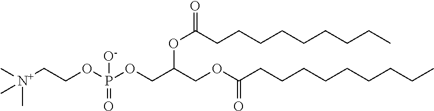

The electronic ink, as disclosed herein, includes nitrogen-linked surface functionalized pigments that are versatile and can be used in electro-optical displays with stacked architecture. Not only can these nitrogen-linked surface functionalized pigments include a broad range of acidic and basic functional groups, they are easier to manufacture since the pigments do not have to be coated with a metal oxide, such as silica, before undergoing functionalization. Additionally, they exhibit better switching behaviors and longer lifetimes due to covalent bonding between the functional group and the pigment particle, as described previously.

It should be understood that the foregoing nitrogen-linked surface functionalized pigments have been described with specific application to electronic inks. However, these nitrogen-linked surface functionalized pigments may find use in other ink technologies that employ non-polar or aqueous inks. Other examples of ink technologies that may use the disclosed nitrogen-linked surface modified pigments include thermal ink jet technology, piezo ink jet technology or liquid electrophotography (LEP) technology used in commercial digital printers.

Further, the foregoing discussion has been directed primarily to stacked cells in an electro-optical display. However, the nitrogen-linked surface functionalized pigments disclosed herein may also be employed in lateral cells in an electro-optical display.

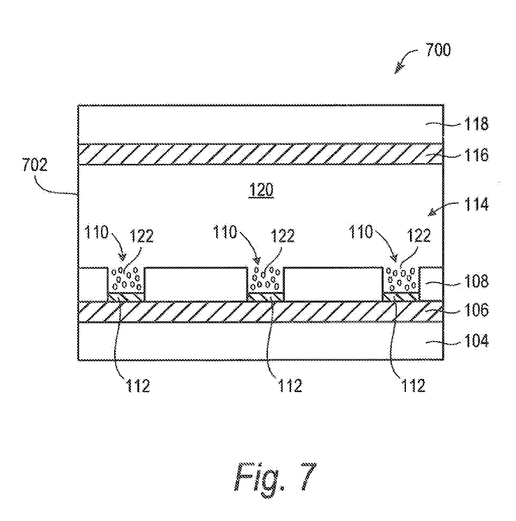

FIG. 7 illustrates a cross-sectional view of one example of a lateral electro-optical display 700. The electro-optical display 700 includes a display element 702a. Additional display elements may be disposed laterally in the x and y directions, with each display element containing inks having colorant particles 122 of different colors.

Each display element 702a is similar to the electro-optical display 100a previously described and illustrated with reference to FIG. 1. Each display element 702a may include thin layers 110a that are self-aligned within recess regions 108. Each display element 702a may also include colorant particles 122 having a color (e.g., cyan, magenta, yellow, black or white) for a full color electro-optical display. In other examples, colorant particles 122 may include other suitable colors for providing an additive or subtractive full color electro-optical display.

What is claimed is:

1. Pigment based inks including:
a non-polar carrier fluid; and
a nitrogen-linked surface functionalized pigment particle, wherein the nitrogen-linked surface pigment particle is suspended in the non-polar carrier fluid and includes an azide moiety linked to the surface of a pigment particle, the azide moiety including an acidic or a basic functional group bonded thereto.

2. The inks of claim 1 wherein the non-polar carrier fluid is a non-polar solvent selected from the group consisting of hydrocarbons, halogenated hydrocarbons, partially halogenated hydrocarbons, and siloxanes.

3. The inks of claim 2 wherein the non-polar solvent is selected from the group consisting of perchloroethylene, cyclohexane, dodecane, mineral oil, isoparaffinic fluids, cyclopentasiloxane, cyclohexasiloxane, and combinations thereof.

4. The inks of claim 1 wherein the pigment particle is selected from the group consisting of black pigment particles, yellow pigment particles, magenta pigment particles, red pigment particles, violet pigment particles, cyan pigment particles, blue pigment particles, green pigment particles, orange pigment particles, brown pigment particles, and white pigment particles.

5. The inks of claim 4 wherein the pigment particle is a colored polymeric particle having a size ranging from 50 nm to 1 μm.

6. The inks of claim 1 wherein the azide moiety is a tetrafluorophenyl azide moiety.

7. The inks of claim 1 wherein the azide moiety includes an acidic functional group selected from the group consisting of —OH, —SH, —COOH, —CSSH, —COSH, —SO₃H, —PO₃H, —OSO₃H, and —OPO₃H.

8. The inks of claim 1 wherein the azide moiety includes a basic functional group selected from the group consisting of trialkylamine, R₁R₂N—, pyridines, substituted pyridines, imidazoles, and substituted imidazoles wherein R₁, R₂ and the substitutions on pyridine and imidazole are, independently, hydrogen, alkyl groups or branched alkyl groups.

9. The inks of claim 1 further including a charge director, wherein the charge director is a small molecule or polymer that is capable of forming reverse micelles in the non-polar carrier fluid.

10. In combination, an electronic display and an electronic ink, wherein the electronic display includes:
a first electrode;
a second electrode; and
a display cell having a recess defined by a dielectric material, the first electrode, and the second electrode, the display cell containing the electronic ink; and wherein the electronic ink includes:
a non-polar carrier fluid; and
a nitrogen-linked surface functionalized pigment particle, wherein the nitrogen-linked surface pigment particle is suspended in the non-polar carrier fluid and includes an azide moiety linked to the surface of a pigment particle, the azide moiety including an acidic or a basic functional group bonded thereto.

11. The combination of claim 10 wherein the electronic display includes a plurality of display cells in a stacked configuration, associated first electrodes and second electrodes, and a plurality of electronic inks of different colors, each display cell containing an electronic ink of a different color.

12. The combination of claim 10 wherein the non-polar carrier fluid is a non-polar solvent selected from the group consisting of hydrocarbons, halogenated hydrocarbons, partially halogenated hydrocarbons, and siloxanes.

13. The combination of claim 10 wherein the azide moiety is a tetrafluorophenyl azide moiety.

14. The combination of claim 10 wherein the azide moiety either includes an acidic functional group selected from the group consisting of —OH, —SH, —COOH, —CSSH, —COSH, —SO₃H, —PO₃H, —OSO₃H, and —OPO₃H and a charge director, wherein the charge director is a small molecule or polymer that is capable of forming reverse micelles in the non-polar carrier fluid, or includes a basic functional group selected from the group consisting of trialkylamine, R₁R₂N—, pyridines, substituted pyridines, imidazoles, and substituted imidazoles wherein R₁, R₂ and the substitutions on pyridine and imidazole are, independently, hydrogen, alkyl groups or branched alkyl groups and a charge director, wherein the charge director is a small molecule or polymer that is capable of forming reverse micelles in the non-polar carrier fluid.

15. The combination of claim 10 wherein the colored pigment is a colored polymeric particle having a size ranging from 50 nm to 1 μm and is selected from the group consisting of black pigment particles, yellow pigment particles, magenta pigment particles, red pigment particles, violet pigment particles, cyan pigment particles, blue pigment particles, green pigment particles, orange pigment particles, brown pigment particles, and white pigment particles.

16. A method for making a nitrogen-linked surface functionalized pigment particle including:
providing an azide moiety;
connecting an amine compound including a functional group to the azide moiety to form an azide including the functional group; and
reacting the azide moiety including the functional group with the surface of a pigment particle to form a covalent bond through a nitrogen of the azide moiety.

17. The method of claim 16 further including:
providing a per-fluorosubstituted aromatic ester; and
reacting the per-fluorosubstituted aromatic ester with an azide salt to form an azide moiety.

18. The method of claim 16 wherein the azide moiety is a tetrafluorophenyl azide moiety.

19. The method of claim 16 wherein the azide moiety either includes an acidic functional group selected from the group consisting of —OH, —SH, —COOH, —CSSH, —COSH, —SO₃H, —PO₃H, —OSO₃H, and —OPO₃H and a charge director, wherein the charge director is a small molecule or polymer that is capable of forming reverse micelles in the non-polar carrier fluid, or a basic functional group selected from the group consisting of trialkylamine, R₁R₂N—, pyridines, substituted pyridines, imidazoles, and substituted imidazoles wherein R₁, R₂ and the substitutions on pyridine and imidazole are, independently, hydrogen, alkyl groups or branched alkyl groups and a charge director, wherein the charge director is a small molecule or polymer that is capable of forming reverse micelles in the non-polar carrier fluid.

20. The method of claim 16 wherein the azide moiety including the functional group is reacted with the pigment particle under UV irradiation at 280-400 nm or is heated to 25-200° C.
